(19) United States
(12) Patent Application Publication
(10) Pub. No.: US 2005/0217329 A1
(43) Pub. Date: Oct. 6, 2005

(54) Anti-drilling structure of a latch

(76) Inventor: Wen-Kwei Chang, Pingtung Hsien (TW)

Correspondence Address: LEONG C LEI, PMB # 1008, 1867 YGNACIO VALLEY ROAD, WALNUT CREEK, CA, 94598, US

(21) Appl. No.: 10/815,776

(22) Filed: Apr. 2, 2004

(51) Int. Cl. E05B 15/16

(52) U.S. Cl. 70/417

(57) ABSTRACT

An anti-drilling structure of a latch is disclosed. The latch comprises an inner shaft body with a non-circular key hole exposed at the external end face of the inner shaft body, characterized in that the external end face of the inner shaft body is provided with an anti-drill plate, a protrusion and a recess structure is provided between the external end face and the anti-drill plate so that the anti-drill plate can be positioned and cover the external end face of the inner shaft body, thereby when the anti-drilling plate is forced to open or damaged by external force, the anti-drilling plate will rotate and the components at the internal section of the latch are protected from damages.

### BACKGROUND OF THE INVENTION

(a) Technical Field of the Invention

The present invention relates to an anti-drilling structure of a latch, and in particular, an anti-drilling structure used in a latch structure having a non-circular key hole.

(b) Description of the Prior Art

The latch of a locker can easily be destroyed or damaged using an electric drill and the locker is thus opened by burglars. Taiwan Patent Publication No. 373677 entitled “An Improved Structure Of A Locker” discloses a locker comprising a shell body mounted with a latch having a latch housing, a plurality of plates and isolating discs. The key hole for such locker has at least two different shapes. The shape of the key hole of the inner plates is rectangular with inward recess at the sides thereof, and the shape of the outer plate is rectangular with an outward recess at the side thereof, and the insertion rod of the key has two sections with different shape. The sides of the front section have a recessed path and the sides of the rear section have a protruded strap which can match with each other with respect to locking and unlocking of the locker. The drawback of the conventional structure is that there is a larger circular hole at the center of a protective plate for protecting the latch, the latch can be destroyed using an electric drill. Thus, the locker is then unlocked. Accordingly, it is an object of the present invention to provide an anti-drilling structure of a latch which mitigates the above drawback.

### SUMMARY OF THE INVENTION

An object of the present invention is to provide an anti-drilling structure of a latch having an inner shaft body with a non-circular key hole exposed at the external end face of the inner shaft body, characterized in that the external end face of the inner shaft body is provided with an anti-drill plate, a protrusion and a recess structure is provided between the external end face and the anti-drill plate so that the anti-drill plate can be positioned and cover the external end face of the inner shaft body, thereby when the anti-drilling plate is forced to open or damaged by external force, the anti-drilling plate will rotate and the components at the internal section of the latch are protected from damages.

A further object of the present invention is to provide anti-drilling structure of a latch, wherein the external end face of the inner shaft body is provided with at least one protrusion.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective exploded view of the present invention.

FIG. 2 is an enlarged view of portion 2 of FIG. 1 of the present invention.

FIG. 3 is a front view of the present invention.

FIG. 4 is a sectional view of line 3-3 of FIG. 3 of the present invention.

FIG. 5 is a schematic view showing the anti-drilling plate being damaged by an electric drill of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

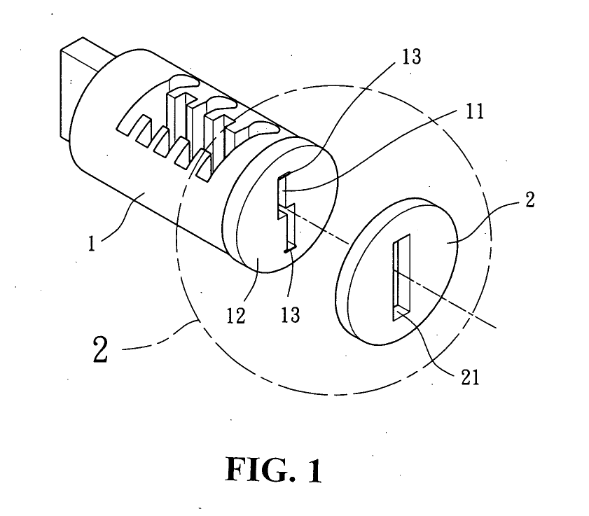

Referring to FIG. 1, there is shown a latch having an inner shaft body 1 made from casted iron or zinc material. The internal section of the inner shaft body 1 has a non circular key hole 11 having an opening exposed at the external end face 12 of the inner shaft body 1. The key hole 11 allows a matching key to be inserted into the inner section of the inner shaft body 1 which can be locked or unlocked with key.

The external end face 12 of the inner shaft body is provided with a protrusion 13 and the height of the protrusion is 0.5 mm, which is the most appropriate height.

The external end face 12 is mounted with an anti-drilling plate 2 made from hard metallic material or specially treated metallic material. The anti-drilling hole 2 has a through hole 21 which matches the key hole 11. Thus, the through hole 21 is also non-circular.

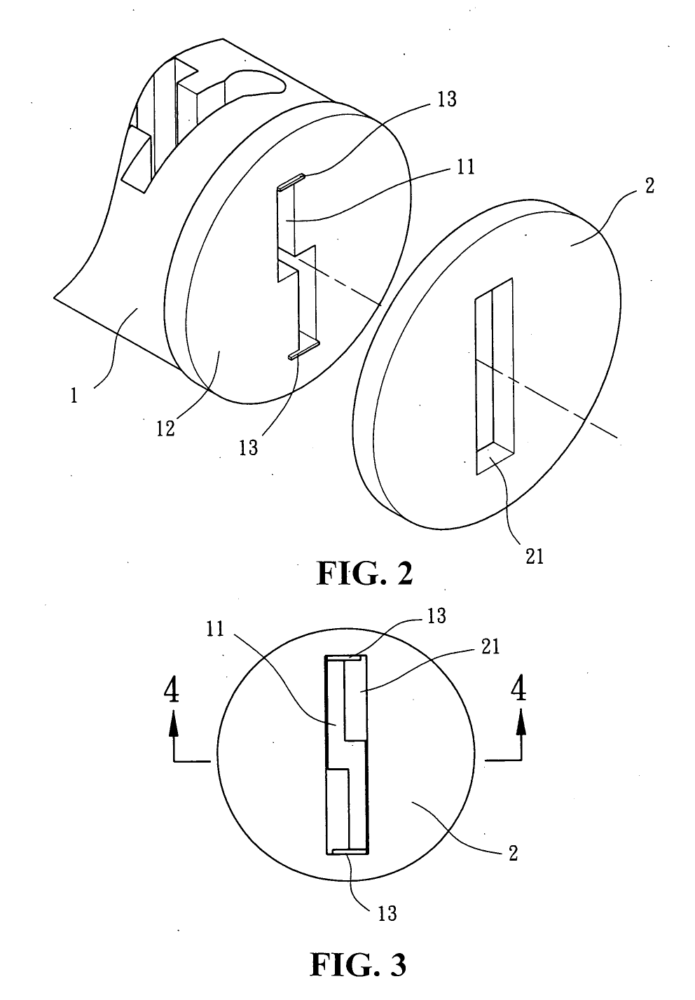

Referring to FIGS. 1, 2 and 3, when the anti-drilling plate 2 matches the external end face 12, the protrusion 13 will engage with the edge of the through hole 21 such that the anti-drilling plate 2 is positioned. Thus the through hole 21 and the key hole 11 match with each other. Thus, it facilitates the insertion of the key into the key hole 11, as shown in FIG. 3.

Further, the engaging and positioning function between the anti-drilling plate 2 and the inner shaft body 1 can have various shape or way of engagement and positioning. For instance, a protrusion and a corresponding recess between the anti-drilling plate 2 and the inner shaft body 1 can be employed such that the anti-drilling plate 2 can be firmly positioned at the outer end face 12 of the inner shaft body 1.

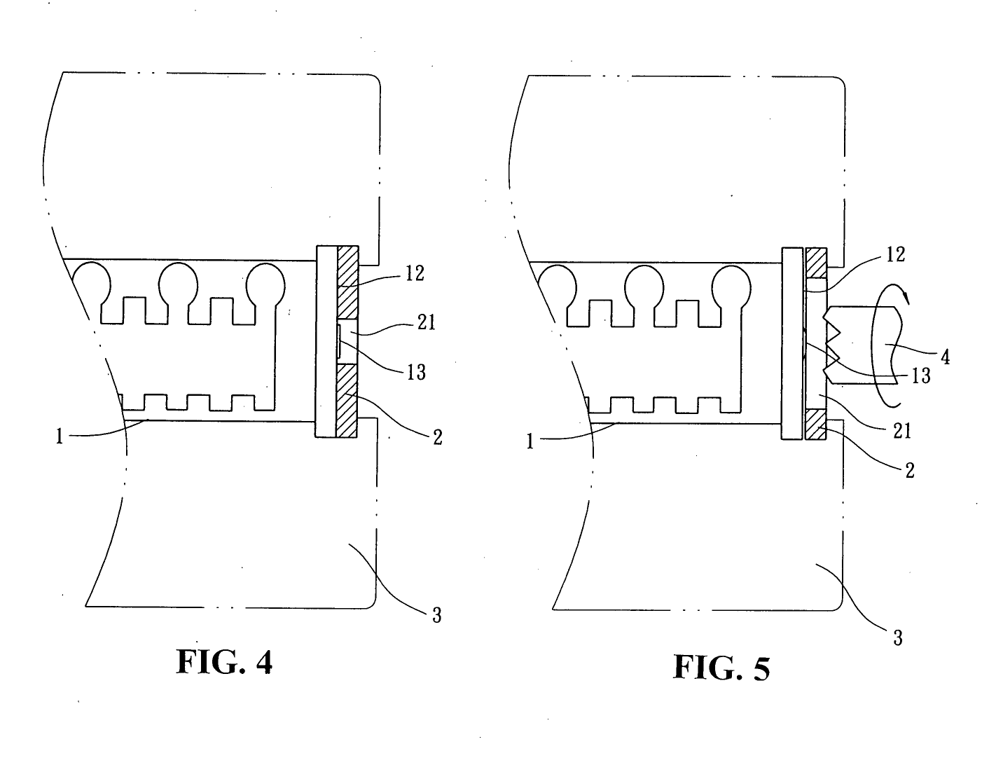

Referring to FIGS. 4 and 5, when the inner shaft body and the anti-drilling plate 5 are mounted within the interior of the body 3 of the locker, together with other components, a complete locker is obtained.

If an electric drill is employed to force open a locker, the tip 4 of the electric drill will first destroy the anti-drilling plate 2 and when the torque exerted onto the anti-drilling plate 1 is exceeded that of the engaging force between the protrusion 13 and the through hole and the frictional force between the two components, the protrusion 13 will be damaged and therefore the anti-drilling plate 2 will rotate together with the drill, as shown in FIG. 5.

In other words, the tip 4 of the electric drill 4 does not have an effective point with respect to applying the force. Accordingly, the tip 4 cannot force open the anti-drilling plate and the other components of the locker will not be damaged. The other components at a deeper position of the latch of the inner shaft will not be damaged.

In view of the above, the anti-drilling plate 2 covering the outer end face 12 of the inner shaft body 1 of the latch and at the same time the protrusion 13 of the inner shaft body 1 engaging with the edge position of the through hole 21 of the anti-drilling plate 2 cause (a) the anti-drilling plate being not freely rotate so as to facilitate the insertion and withdrawal of key through the key hole 11 and (b) the anti-drilling plate 2 to rotate together with the tip of the electric drill if the anti-drilling plate 2 is damaged. Therefore, the components at the inner section of the locker can be protected.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1-4. (canceled)

5. An anti-drilling structure of a latch comprising an inner shaft body, said inner shaft body having an internal section formed with a non-circular hole having an opening exposed at an external end face of said inner shaft body, said key hole, said external end face being provided with at least one protrusion, said external end face being mounted with an anti-drilling plate, said anti-drilling plate having a through hole which matches said key hole, said through hole being non-circular, said protrusion being engaged with said through hole thereby making said through hole match said key hole, whereby when an electric drill is employed to try to damage said anti-drilling plate, said anti-drilling plate will be turned to break said protrusion thereby causing said anti-drilling plate to rotate in unison with said drill and therefore preventing said inner shaft body from being damaged.

6. The anti-drilling structure of a latch as claimed in claim 5, wherein said protrusion has a height of 0.5 mm.
